(19) United States
(12) Patent Application Publication
(10) Pub. No.: US 2026/0289966 A1
(43) Pub. Date: Sep. 24, 2026

(54) Confidence-Based Object Classification of Two-Wheeled Vehicles

(71) Applicant: Bayerische Motoren Werke Aktiengesellschaft, Muenchen (DE)

(72) Inventor: Alvaro MARCOS-RAMIRO, Muenchen (DE)

(21) Appl. No.: 19/571,743

(22) Filed: Mar. 19, 2026

(30) Foreign Application Priority Data
Mar. 20, 2025 (DE) 10 2025 110 813.7

(51) Int. Cl. G06V 10/764; G06V 20/58; G06V 40/10

(52) U.S. Cl. CPC G06V 10/764; G06V 20/58; G06V 40/10; G06V 2201/08

(57) ABSTRACT

A computer-implemented method for a motor vehicle to classify an object includes acquiring a first class associated with the object, a second class associated with the object, a first confidence, and a second confidence. The first confidence indicates a probability according to which the object belongs to the first class. The second confidence indicates a probability according to which the object belongs to the second class. The method includes determining, in consideration of the first confidence and the second confidence, a target class classifying the object. The method includes outputting the target class.

### CROSS REFERENCE TO RELATED APPLICATION

This application claims priority under 35 U.S.C. §119 from German Patent Application No. 10 2025 110 813.7, filed March 20, 2025, the entire disclosure of which is herein expressly incorporated by reference.

### BACKGROUND AND SUMMARY

The present disclosure relates to a computer-implemented method for a motor vehicle for classifying an object. The disclosure also relates to a computer program and/or computer-readable medium, a data processing device, and a motor vehicle.

Such methods are known from the prior art. The classifications of objects in the surroundings of the motor vehicle can have influence on, for example, automated and/or autonomous driving functions in this case.

In the field of motor vehicles, in particular providing an object detector configured to output one of multiple classes for an object recognized as a road user, for example one of the four classes "vehicle", "truck", "person", and "two-wheeled vehicle", is known.

The class "two-wheeled vehicle" comprises in this case a detection of any objects having two wheels, such as motorcycles, bicycles, scooters, and/or push bikes, wherein the object is ridden. In other words, such vehicles, such as motorcycles, bicycles, scooters, and/or push bikes, which are not being ridden are not to be output as an object in the class "two-wheeled vehicle". For example, a bicycle parked on a sidewalk is not to be output as an object in the class "two-wheeled vehicle" since it should not have any relevant influence on, for example, an automated and/or autonomous driving function.

However, it has been shown that the training and/or the configuration of an object detector does not converge with regard to the classes "two-wheeled vehicle" and "person" as classes exclusive from one another. This can result in a performance loss of the object detector for the other classes as well.

Various approaches are known from the prior art for countering the problem of the performance loss of an object detector caused by this.

For example, carrying out a so-called flat classification is known, wherein from a tree of classes, thus hierarchically formed classes, classification is only performed with regard to the leaves, thus the end nodes of a respective branch. Silla, C.N., Freitas, A.A. A survey of hierarchical classification across different application domains. Data Min Knowl Disc 22, 31–72 (2011). https://doi.org/10.1007/s10618-010-0175-9 gives an overview here of hierarchical classification. Wu, Cinna, Mark Tygert, and Yann LeCun. "A hierarchical loss and its problems when classifying non-hierarchically." PloS one 14.12 (2019): e0226222 describes a metric for quantifying erroneous classifications.

Applying local classifiers, which take into consideration a predetermined granularity, is also known. However, this can increase the complexity of the model underlying the classifier and the training, which can result in development and hardware costs.

Moreover, so-called "Big Bang" approaches are known, in which each node of a tree is taken into consideration.

However, it has been shown that the above-mentioned problem of convergence cannot be remedied by the mentioned approaches. Moreover, the use of the mentioned approaches requires training directed to the respective approach, adapting parameters, and/or they are difficult to comprehend in the resulting findings.

Against the background of this prior art, an object of the present disclosure is to specify a method suitable for enhancing the prior art and at least improving the above-mentioned aspects of the prior art. In particular, it is an object of the disclosure to achieve improved recognition of objects in the use in a motor vehicle.

At least this object is achieved by the features of the one or more embodiments disclosed herein, which illustrate the principles of the invention. It will be understood that the described features are not limited combination in the specific embodiments disclosed, but rather may be combined in any combination consistent with the principles disclosed herein without departing from the scope of the invention.

Accordingly, at least this object is achieved according to at least one aspect of the disclosure by a computer-implemented method for a motor vehicle for classifying an object; wherein the method comprises: detecting a first class associated with the object, a second class associated with the object, a first confidence, and a second confidence, wherein the first confidence specifies a probability according to which the object belongs to the first class, and the second confidence specifies a probability according to which the object belongs to the second class; determining, in consideration of the first confidence and the second confidence, a target class classifying the object; and outputting the target class to a driving automation system function, wherein the driving automation system function is configured to control a longitudinal guidance and/or lateral guidance of the motor vehicle based on the target class.

It has been recognized that an object detector can output not only one class, but rather multiple classes each having a confidence. The combination of classes and confidence can be used to assign the object to a target class according to a predetermined logic by way of a processing step ("postprocessing") downstream from the object detector.

This can avoid the necessity that the object has to be assigned to precisely one of the classes by the object detector. The possible convergence problems connected thereto can thus be avoided, by which the object recognition is improved. Furthermore, the method can be applied independently of a training of a model or object detector, since the method can be implemented as a decision logic downstream from the object detector and based on the confidences, due to which the improved object recognition is implementable in a comparatively easy, cost-effective, and resource-preserving manner.

The target class is the first class, the second class, or an empty class. A possible confusion between the first class and the second class can therefore be resolved in a well-defined manner on the basis of the determination of the target class. Alternatively or additionally to the empty class, a definition of the target class may also not take place and/or the output of the target class may not take place. The empty class can also be designated as a "void". The first class is "person"; and the second class is "two-wheeled vehicle" in this case. It is therefore possible that the object detector upstream from the method can be independently trained with respect to the classes "person" and "two-wheeled vehicle".

The first class is determined as the target class if the first confidence exceeds a threshold value and the second confidence falls below a threshold value; the second class is determined as the target class if the first confidence and the second confidence each exceed a threshold value; and an empty class is determined as the target class if the first confidence falls below a threshold value and the second confidence exceeds a threshold value. A specific logic is therefore specified, on the basis of which the target class can be determined. The statement that for this purpose a confidence exceeds or falls below a threshold value means that the confidence is comparatively high or comparatively low, for example, the confidence for one class is greater or less than the confidence for another class.

In the context of the present disclosure, the term driving automation system function (SAE 3016: driving automation system feature functionality) is any arbitrary design-specific driving automation function of an arbitrary level 1 to 5 driving automation of the driving automation taxonomy according to the standard J3016 of the SAE International, such as a level 3 freeway assistant or an adaptive cruise control. Accordingly, the driving automation system function can control the longitudinal guidance and/or the lateral guidance of the motor vehicle, wherein depending on the level, the driver monitors the driving automation system function, serves as a fallback level, or does not exert any influence on the longitudinal guidance and the lateral guidance.

The method optionally comprises: determining, on the basis of sensor data acquired by a motor vehicle-side sensor device, the first class and the second class; and the determination of the target class and the outputting are carried out as postprocessing in relation to the determination of the first class and the second class. The determination of the target class can therefore take place as downstream data processing ("postprocessing"), in order to effectively avoid confusion of the object director.

The method optionally comprises: acquiring, by way of a motor vehicle-side sensor device, sensor data; wherein the object is depicted in the sensor data. The method can therefore be carried out effectively on the basis of the sensor data. The motor vehicle-side sensor device can in particular acquire surroundings data here in order to be able to characterize the surroundings of the motor vehicle.

The sensor data optionally comprise image data. On the basis of image data, for example, the recognition of objects can be particularly effective and useful for carrying out automated and/or autonomous driving functions.

According to at least one aspect of the disclosure, a computer program and/or a computer-readable medium is/are provided. The computer program and/or the computer-readable medium comprise(s) instructions which, when the program or the instructions is/are executed by a data processing device, cause the latter to carry out the method according to the disclosure and/or steps thereof. Optionally, the computer program and/or the computer-readable medium comprise(s) instructions which, when the program or the instructions is/are executed by a data processing device, cause the latter to carry out the method steps described as advantageous or optional in order to achieve an associated technical effect.

According to at least one aspect of the disclosure, a data processing device for a motor vehicle is provided. The data processing device is configured to carry out the method according to the disclosure. Optionally, the data processing device is configured to carry out a method step described as advantageous or optional and/or to implement a method feature in order to achieve an associated technical effect.

According to at least one aspect of the disclosure, a motor vehicle comprising the data processing device according to the disclosure is provided. Optionally, the data processing device of the motor vehicle and/or the motor vehicle is/are configured to carry out a method step described as advantageous or optional and/or to implement a method feature in order to achieve an associated technical effect.

At least one embodiment is described below with reference to the figures.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a motor vehicle according to one aspect of the disclosure;

FIG. 2 schematically shows a flow chart of a method according to one aspect of the disclosure;

FIG. 3 shows a schematic representation of a computer program and/or computer-readable medium according to one aspect of the disclosure;

FIG. 4 shows performance metrics by way of example;

FIG. 5 shows sensor data with objects and the classes thereof by way of example; and

FIG. 6 shows performance metrics by way of example.

### DETAILED DESCRIPTION OF THE DRAWINGS

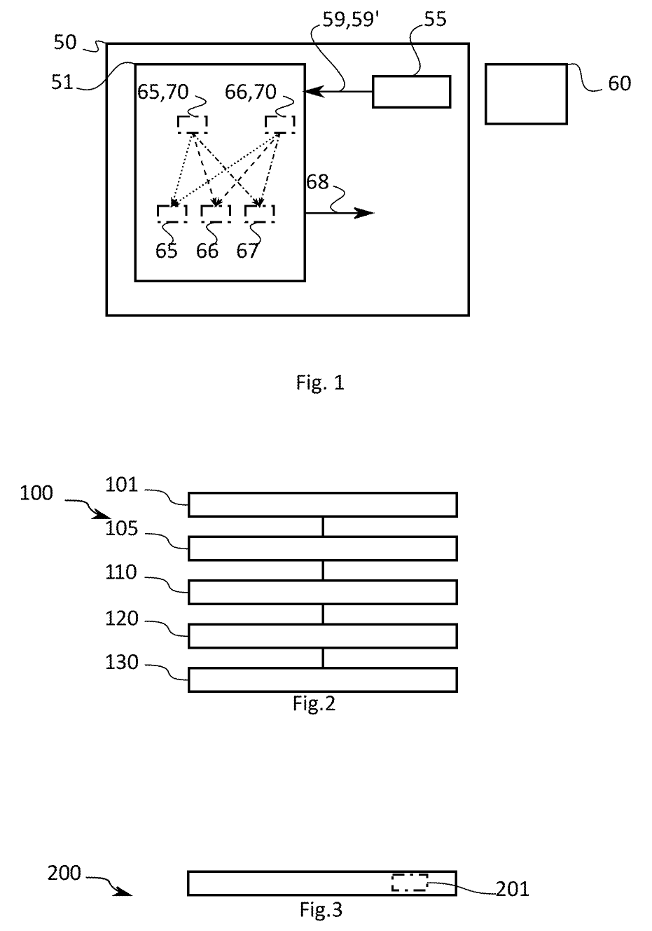

FIG. 1 schematically shows a motor vehicle 50 according to one aspect of the disclosure. The motor vehicle 50 is a land vehicle. The motor vehicle 50 is a passenger vehicle, for example.

Moreover, FIG. 1 illustrates an object 60. The object 60 is arranged in the surroundings of the motor vehicle 50. The object 60 is a road user.

The motor vehicle 50 comprises a data processing device 51. The motor vehicle 50 or the data processing device 51 is configured to carry out the method 100 described with reference to FIG. 2. For this purpose, the motor vehicle 50 according to FIG. 1 has a sensor device 55.

The data processing device 51 and the sensor device 55 have a communication connection to one another. The sensor device 55 is configured to acquire sensor data 59 and transmit them to the data processing device 51. The sensor data 59 characterize the object 60 and/or depict the object 60. Therefore, the sensor data 59 comprise information about the object 60 which can be processed by the data processing device 51.

The sensor device 55 comprises a camera, for example. The sensor data 59 therefore comprise image data 59'. The sensor device 55 can include further components, such as a radar device and/or a lidar device.

The data processing device 51 is configured to acquire the sensor data 59, wherein the object 60 is depicted in the sensor data 59.

The data processing device 51 is configured to determine a first class 65 and a second class 66 on the basis of the sensor data 59. The data processing device 51 can include an object detector for this purpose, thus, for example, implement a component in the form of software, which is configured to process the sensor data 59 in order to recognize and classify the object 60 in the sensor data 59.

The data processing device 51 is configured to detect a first class 65 associated with the object 60, a second class 66 associated with the object 60, a first confidence 70, and a second confidence 71. For this purpose, the data processing device 51 can implement a post-processor in the form of software, for example. The first confidence 70 indicates a probability according to which the object 60 belongs to the first class 65. The second confidence 71 indicates a probability according to which the object 60 belongs to the second class 66.

The first class 65 is "person". The second class 66 is "two-wheeled vehicle". The first confidence 70 therefore indicates with which probability the object 60 has been classified or recognized as a person. The second confidence 71 indicates with which probability the object 60 has been classified as a two-wheeled vehicle. The object 60 can belong with respective probabilities to the first class 65 and lastly the second class 66.

The data processing device 51 is configured to determine a target class 68 classifying the object 60 in consideration of the first confidence 70 and the second confidence 71. The target class 68 is the first class 65, the second class 66, or an empty class 67.

The first class 65 is determined as the target class 68 if the first confidence 70 exceeds a threshold value and the second confidence 71 falls below a threshold value. In other words, the target class 68 is "person" if the first confidence 70 is high and the second confidence 71 is low.

The second class 66 is determined as the target class 68 if the first confidence 70 and the second confidence 71 each exceed a threshold value. In other words, the target class 68 is "two-wheeled vehicle" if the first confidence 70 is high and the second confidence 71 is high.

The empty class 67 is determined as the target class 68 if the first confidence 70 falls below a threshold value and the second confidence 71 exceeds a threshold value. In other words, the target class 68 is empty or the output of a target class 68 does not take place if the first confidence 70 is low and the second confidence 71 is high.

The data processing device 51 is configured to output the target class 68. The output of the target class 68 can comprise, for example, an output in a downstream software module implemented by the data processing device 51 and/or an output to a control unit to carry out automated and/or autonomous driving functions.

The determination 120 of the target class 68 and the output 130 are carried out as postprocessing in relation to the determination 105 of the first class 65 and the second class 66. In other words, the target class 68 is determined downstream from the object detector in that a predetermined decision logic is applied on the basis of the first confidence 70 and the second confidence 71.

FIG. 2 schematically shows a flow chart of a method 100 according to one aspect of the disclosure. The method 100 according to FIG. 2 is a computer-implemented method 100 for a motor vehicle 50 for classifying an object 60. Such a motor vehicle 50 is described with reference to FIG. 1. FIG. 2 is described with reference to FIG. 1.

The method 100 according to FIG. 2 includes: Acquiring 101, by a motor vehicle-side sensor device 55, sensor data 59. An object 60 is depicted in the sensor data 59. The sensor data 59 comprise image data 59'.

The method 100 includes: Determining 105, on the basis of sensor data 59 acquired by a motor vehicle-side sensor device 55, the first class 65 and the second class 66. The first class 65 is "person". The second class 66 is "two-wheeled vehicle".

The method 100 includes: Acquiring 110 a first class 65 associated with the object 60, a second class 66 associated with the object 60, a first confidence 70, and a second confidence 71, wherein the first confidence 70 indicates a probability according to which the object 60 belongs to the first class 65, and the second confidence 71 indicates a probability according to which the object 60 belongs to the second class 66.

The method 100 includes: Determining 120, in consideration of the first confidence 70 and the second confidence 71, a target class 68 classifying the object 60.

The target class 68 is the first class 65, the second class 66, or an empty class 67.

The first class 65 is determined as the target class 68 if the first confidence 70 exceeds a threshold value and the second confidence 71 falls below a threshold value.

The second class 66 is determined as the target class 68 if the first confidence 70 and the second confidence 71 each exceed a threshold value.

The empty class 67 is determined as the target class 68 if the first confidence 70 falls below a threshold value and the second confidence 71 exceeds a threshold value.

The method 100 includes: Outputting 130 the target class 68.

Determining 120 the target class 68 and outputting 130 are carried out as postprocessing in relation to determining 105 the first class 65 and the second class 66.

In this case, a person skilled in the art recognizes that the method 100 according to FIG. 2 can also be carried out in a sequence other than that shown. In particular, it is possible for steps of the method 100 to be able to be swapped, shifted, repeated and/or carried out simultaneously.

FIG. 3 shows a schematic representation of a computer program and/or computer-readable medium 200 according to one aspect of the disclosure. The computer program and/or computer-readable medium 200 comprise(s) commands 201 which, when the program or the commands 201 is/are executed by a data processing device 51, cause the latter to carry out the method 100 and/or the steps of the method 100 according to FIG. 2.

The commands 201 may be present as a program code in any code or in any language, in particular in a code suitable for controlling and/or monitoring motor vehicles 50. The computer program and/or computer-readable medium 200 may be or comprise any digital data storage device, such as a USB stick, a hard disk, a CD-ROM, an SD card, or an SSD card. The computer program does not necessarily have to be stored on such a computer-readable storage medium, but may also be retrieved via the Internet or otherwise.

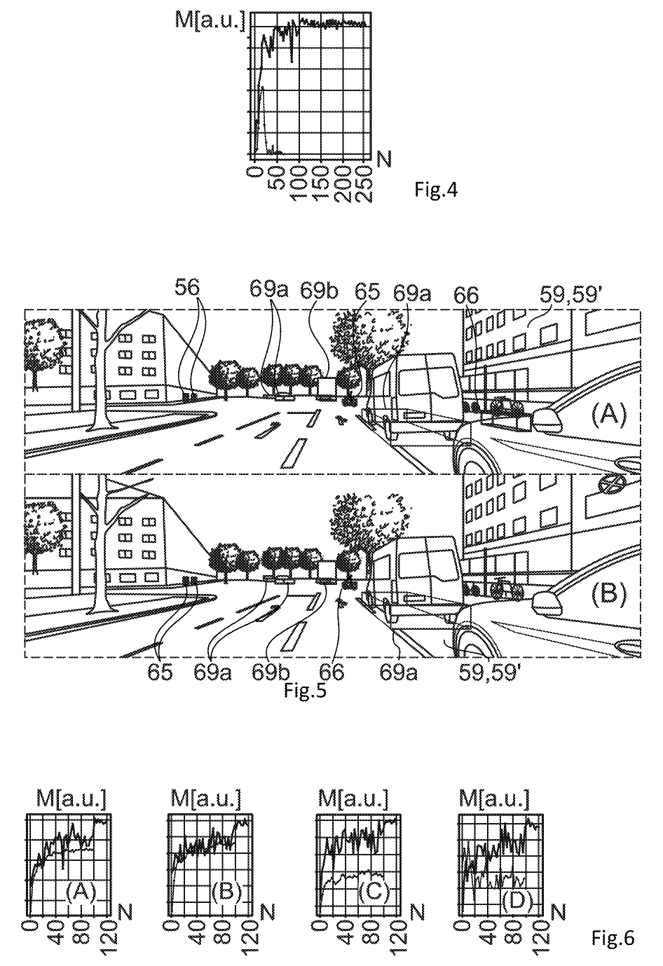

FIG. 4 shows performance metrics M by way of example. The performance metric M is a so-called "mean average precision" (mAP). The performance metric M is shown as a function of a number N of training epochs. Two curves are illustrated in FIG. 4, wherein the lower of the two curves shows the performance metric M according to the prior art, thus according to which the object detector has to make a strict decision between the class "person" and the class "two-wheeled vehicle" and can assign an object 60 to only exactly one of the classes. It can occur here that an object 60 which is provided, for example, by a bicyclist with a bicycle, is classified as the class "person". The upper of the two curves shows the performance metric M according to the method 100 from FIG. 2. The performance metric M for the method 100 from FIG. 2 displays better values throughout here than according to the prior art. An exemplary scenario is illustrated with reference to FIG. 5.

FIG. 5 shows sensor data 59 with objects 60 and the classes thereof by way of example. The sensor data 59 are image data 59'. A plurality of objects 60 (not indicated for the sake of clarity) is represented in the sensor data, wherein the result of the object recognition or the corresponding classes of the objects 60 are shown. FIG. 5 is divided into two sections (A) and (B), wherein section (A) shows object recognition according to the prior art and section (B) shows object recognition according to the method 100 from FIG. 2.

According to the prior art, in section (A) in the right area of the sensor data 59, an object 60 is recognized as belonging to the class "two-wheeled vehicle" or the second class 66, although the object 60 should not be recognized as an object 60, since it is a bicycle which is not being ridden. Moreover, a bicycle being ridden in the middle area of the sensor data 59 is recognized as belonging to the class "person" or the first class 65.

Moreover, objects 60 are recognized in the class "vehicle" or a third class 69a and an object 60 is recognized in the class "truck" or a fourth class 69b.

According to the method 100 from FIG. 2, in section (B) in the right area of the sensor data 59, the bicycle is not recognized as an object 60. The object 60 in the middle area of the sensor data 59 is correctly recognized as belonging to the class "two-wheeled vehicle" or the second class 66.

FIG. 6 shows performance metrics M by way of example. FIG. 6 is divided into four sections (A), (B), (C), and (D). Sections (A) to (D) each show for comparison the performance metric M for the method 100 from FIG. 2 and a reference curve ("baseline"), wherein section (A) relates to the third class 69a or the class "vehicle", section (B) relates to the fourth class 69b or the class "truck", section (C) relates to the first class 65 or the class "person", and section (D) relates to the second class 66 or the class "two-wheeled vehicle". The performance metrics M are higher for all classes for the method 100 from FIG. 2 than for the prior art.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

50 motor vehicle

51 data processing device

55 sensor device

59 sensor data

59' image data

60 object

65 first class

66 second class

67 empty class

68 target class

69a third class

69b fourth class

70 first confidence

71 second confidence

100 method

101 acquisition of sensor data

105 determination of a first class and a second class

110 acquisition of the first class, the second class, the first confidence, and the second confidence

120 determination of the target class

130 output

200 computer program and/or computer-readable medium

201 commands

M performance metric

N number

What is claimed is:

1. A computer-implemented method for classifying an object, comprising:
acquiring a first class associated with the object, a second class associated with the object, a first confidence, and a second confidence, wherein the first confidence indicates a probability according to which the object belongs to the first class, and the second confidence indicates a probability according to which the object belongs to the second class, wherein the first class is "person" and the second class is "two-wheeled vehicle";
determining, in consideration of the first confidence and the second confidence, a target class classifying the object, wherein:
the first class is determined as the target class if the first confidence exceeds a threshold value and the second confidence falls below a threshold value,
the second class is determined as the target class if the first confidence and the second confidence each exceed a threshold value, and
an empty class is determined as the target class if the first confidence falls below a threshold value and the second confidence exceeds a threshold value; and
outputting the target class to a driving automation system function, wherein the driving automation system function is configured to control a longitudinal guidance and/or lateral guidance of a motor vehicle based on the target class.

2. The method of claim 1, further comprising:
determining, on the basis of sensor data acquired by a motor vehicle-side sensor device, the first class and the second class; and
determining the target class and outputting are carried out as postprocessing in relation to determining the first class and the second class.

3. The method of claim 1, further comprising:
acquiring, by way of a motor vehicle-side sensor device, sensor data,
wherein the object is depicted in the sensor data.

4. The method of claim 2, wherein the sensor data comprise image data.

5. A non-transitory computer-readable medium storing instructions that when executed by a processor cause the processor to carry out the method of claim 1.

6. A data processing device for a motor vehicle, wherein the data processing device is configured to carry out the method of claim 1.

7. A motor vehicle comprising:
the data processing device of claim 6.
